(19) United States
(12) Patent Application Publication
(10) Pub. No.: US 2009/0225033 A1
(43) Pub. Date: Sep. 10, 2009

(54) Electronic Apparatus

(75) Inventor: Masakazu Hosoda, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/252,947

(22) Filed: Oct. 16, 2008

(30) Foreign Application Priority Data
Mar. 5, 2008 (JP) 2008-055300

(51) Int. Cl. G09G 5/00

(52) U.S. Cl. 345/170

(57) ABSTRACT

According to one embodiment, an electronic apparatus includes: a keyboard provided with a plurality of keys and a plurality of LEDs arranged around each of the keys; a storage unit configured to store information indicating relationship between the keys and corresponding LEDs; a detecting unit configured to detect a key input at one of the plurality of keys; and an LED controlling unit configured to light at least one of the LEDs corresponding to the one of the keys based on the information when the detecting unit detects the key input.

### CROSS-REFERENCE TO RELATED APPLICATIONS

This application is based upon and claims the benefit of priority from Japanese Patent Application No. 2008-055300, filed on Mar. 5, 2008, the entire contents of which are incorporated herein by reference.

### BACKGROUND

1. Field

One embodiment of the invention relates to an electronic apparatus that includes a keyboard in which a plurality of LEDs are arranged around each of keys, and in which the LEDs can be lighted based on a key input.

2. Description of the Related Art

In a keyboard, usually, keys for inputting characters and commands, a power button, and the like are arranged on a face. A keyboard is most commonly used as inputting means for a Personal Computer (PC) or the like. In such a keyboard, in order to check whether, when the user presses a key, the key input is correctly performed or not, the user has to check a screen of a display device. In this case, some users feel it stressful to stare small characters displayed on the screen.

Therefore, a keyboard switch in which a display unit and switch unit are separated from each other by a certain space has been proposed (see JP-A-4-22020, for instance). In the keyboard switch, when a switch is pressed, a membrem is pressed to conduct an input, and an LED emits light to illuminate the pressed switch. Accordingly, the user can check whether, when a key is pressed, the key is correctly input.

When the user presses a key, usually, the key is pressed in a state where a finger covers the key. In the configuration where only a part of the pressed key emits light, therefore, there is a problem in that, in order to check the light, the user may release the finger from the keyboard.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a first embodiment of the electronic apparatus of the invention;

FIG. 2 is an exemplary block diagram showing the electronic apparatus of the first embodiment;

FIG. 3 is an exemplary view showing arrangements of keys and LEDs of a keyboard in the first embodiment;

FIG. 4 is an exemplary data diagram showing control information in the first embodiment;

FIG. 5 is an exemplary flowchart showing the procedure in the case where the electronic apparatus of the first embodiment performs a lighting control process;

FIG. 6 is a view illustrating an example in the case where a key of S is pressed, in the lighting control process of the electronic apparatus of the first embodiment;

FIG. 7 is a view illustrating an example in the case where the key of S is released, in the lighting control process of the electronic apparatus of the first embodiment;

FIG. 8 is an exemplary data diagram showing control information in a second embodiment;

FIG. 9 is an exemplary flowchart showing the procedure in the case where an electronic apparatus of the second embodiment performs a lighting control process;

FIG. 10 is a view illustrating an example in the case where the key of S is pressed, in the lighting control process of the electronic apparatus of the second embodiment;

FIG. 11 is a view illustrating the example in the case where the key of S is pressed, in the lighting control process of the electronic apparatus of the second embodiment;

FIG. 12 is an exemplary view showing arrangements of keys and LEDs of a keyboard in a third embodiment;

FIG. 13 is an exemplary data diagram showing control information in the third embodiment;

FIG. 14 is an exemplary flowchart showing the procedure in the case where the electronic apparatus of the third embodiment performs a lighting control process;

FIG. 15 is a view illustrating an example in the case where the key of S is pressed, in the lighting control process of the electronic apparatus of the third embodiment;

FIG. 16 is a view illustrating the example in the case where the key of S is pressed, in the lighting control process of the electronic apparatus of the third embodiment; and

FIG. 17 is a view showing an example of arrangements of keys and LEDs of a keyboard.

### DETAILED DESCRIPTION

Various embodiments according to the invention will be described hereinafter with reference to the accompanying drawings. In general, according to one embodiment of the invention, an electronic apparatus includes: a keyboard provided with a plurality of keys and a plurality of LEDs arranged around each of the keys; a storage unit configured to store information indicating relationship between the keys and corresponding LEDs; a detecting unit configured to detect a key input at one of the plurality of keys; and an LED controlling unit configured to light at least one of the LEDs corresponding to the one of the keys based on the information when the detecting unit detects the key input.

### First Embodiment

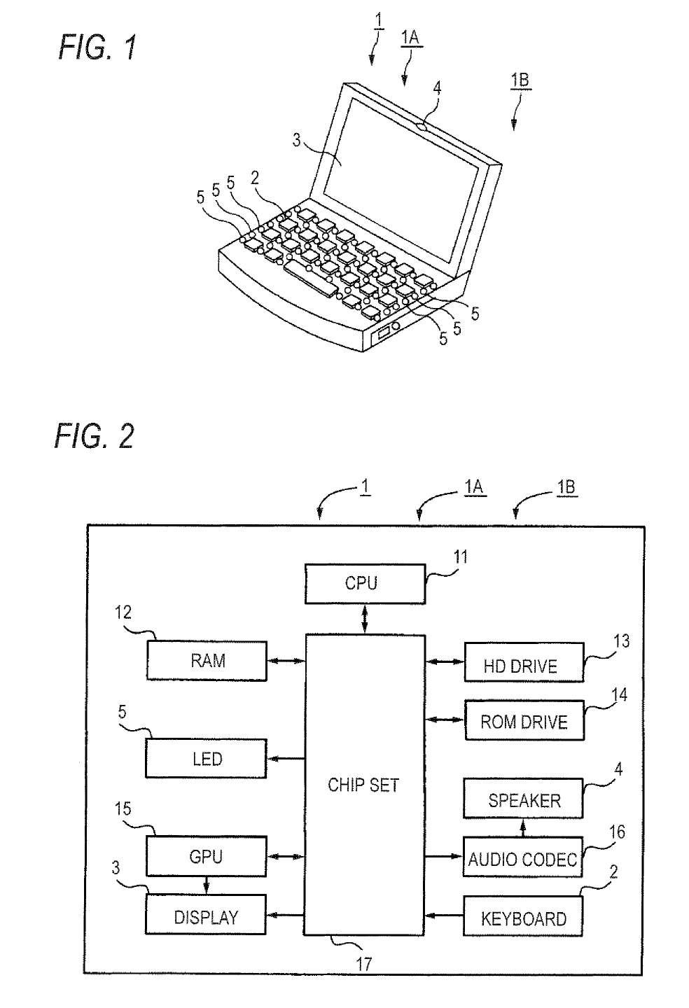

A first embodiment of the electronic apparatus of the invention will be described with reference to FIGS. 1 to 7. FIG. 1 is an exemplary perspective view of the electronic apparatus 1 of the invention. The electronic apparatus 1 is a notebook Personal Computer (PC) which is usually used, or the like. In the electronic apparatus, as shown in FIG. 1, a keyboard 2 having a plurality of keys which are pressed when the user inputs instructions, a display device 3 which displays a screen showing characters, images, and the like, a speaker 4 which outputs sounds, and a plurality of LEDs 5 which are disposed in the keyboard 2, and which are lighted based on press of keys of the keyboard 2 are disposed so as to be exposed to the outside.

FIG. 2 is an exemplary block diagram of the electronic apparatus 1. As shown in FIG. 2, the electronic apparatus 1 includes at least a Central Processing Unit (CPU) 11, a Random Access Memory (RAM) 12, an Hard Disk (HD) drive 13, a Read Only Memory (ROM) drive 14, a GPU 15, and an audio codec 16. These components are interconnected by a chip set 17.

The CPU 11 generally controls the electronic apparatus 1, and performs a lighting control process which will be described later, and other various calculation and control processes. The CPU 11 includes an input interface for the keyboard 2, detects that a key of the keyboard 2 is pressed and the key is released, and performs various processes based on the pressed key. The CPU 11 further includes an output interface for each of the LEDs 5, and controls the LEDs 5 so as to be lighted based on, for example, press on the keys of the keyboard 2.

The RAM 12 is used as a working area when the CPU 11 performs a process, and temporarily stores data required in the process. The HD drive 13 is a driving device for applying writing and reading operations on a Hard Disk (HD) which stores process program required in processes to be performed by the CPU 11, and data necessary for the processes. The ROM drive 14 is a driving device for applying writing and reading operations on a recording medium such as a Digital Versatile Disk (DVD) on which video data or the like are recorded.

The GPU 15 includes a video RAM which temporarily stores character or graphic data to be displayed on the display device 3, and which is used in a process of two-dimensional graphics (2D) or three-dimensional graphics (3D) or a motion picture process, and, under the control of the CPU 11, outputs frame data loaded in the video RAM to the display device 3.

The audio codec 16 includes an output interface which causes the speaker 4 disposed on the electronic apparatus 1 to output a sound, and, under the control of the CPU 11, converts a digital audio signal to an analog signal, and then outputs it as a sound from the speaker 4.

The chip set 17 is an integrated circuit including a memory controller, a bus bridge, an Integrated Drive Electronics (IDE) controller, various I/O controllers, etc.

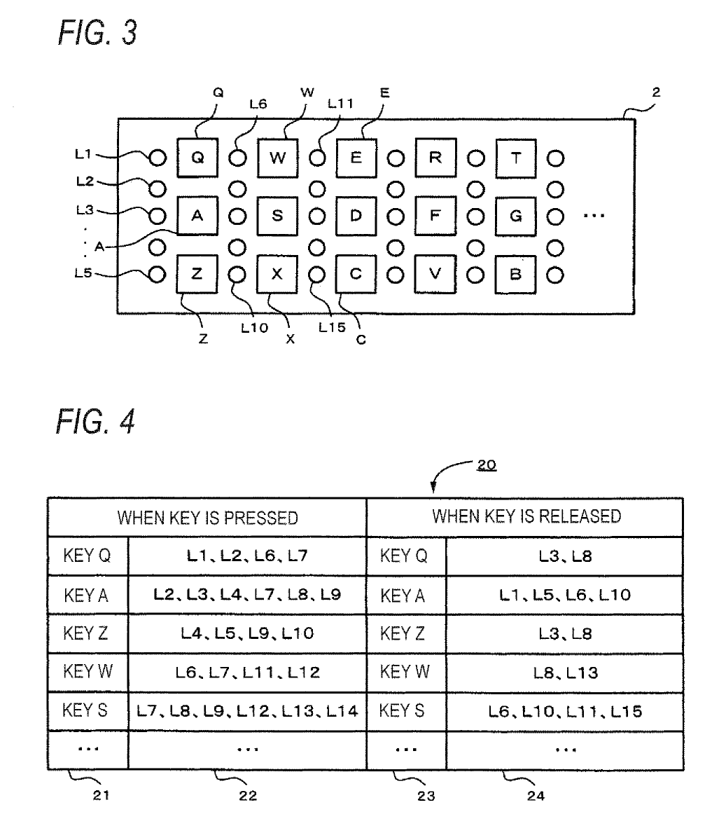

A plurality of keys and a plurality of LEDs 5 are arranged on the face of the keyboard 2. FIG. 3 shows an example of the arrangements of the plural keys and LEDs 5 on the keyboard 2. In the keyboard 2, the plural keys through which the user can input characters and commands are arranged in a lattice-like manner. Columns of the LEDs 5 which are vertically arranged are disposed between respective columns of the keys which are similarly vertically arranged, so that the columns of the keys and those of the LEDs 5 are alternately arranged. As shown in FIG. 3, for example, five LEDs 5 (the identification numbers are L1 to L5) are arranged between the column of keys of Q, A, and Z and that of keys of W, S, and X. Moreover, five LEDs 5 (the identification numbers are L6 to L10) are arranged between the column of the keys of W, S, and X and that of keys of E, D, and C.

The HD stores control information 20 indicating methods of lighting LEDs in the case where a key of the keyboard 2 is pressed, and that in the case where the key is released. In the control information 20, as shown in FIG. 4, sets of key information 21 indicating the keys of the keyboard 2 are associated with those of lighting information 22 indicating the LEDs 5 which are lighted when a corresponding key is pressed, respectively, and sets of key information 23 indicating the keys of the keyboard 2 are associated with those of the lighting information 22 indicating the LEDs 5 which are lighted when a corresponding key is released, respectively.

According to FIG. 4, for example, the key information 21 of “Key Q” is associated with the lighting information 22 of “L1, L2, L6, L7”, and the key information 21 of “Key A” is associated with the lighting information 22 of “L2, L3, L4, L7, L8, L9”. This means that, when the key of Q is pressed, the LEDs 5 of L1, L2, L6, and L7 are lighted, and, when the key of A is pressed, the LEDs 5 of L2, L3, L4, L7, L8, and L9 are lighted.

According to FIG. 4, furthermore, the key information 23 of “Key Q” is associated with the lighting information 24 of “L3, L8”, and the key information 23 of “Key A” is associated with the lighting information 24 of “L1, L5, L6, and L10”. This means that, when the key of Q is released, the LEDs 5 of L3, L8 are lighted, and, when the key of A is released, the LEDs 5 of L1, L5, L6, and L10 are lighted.

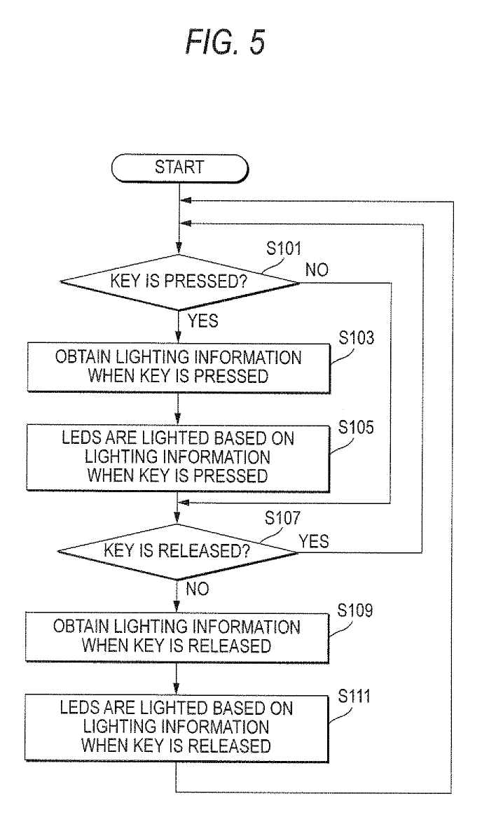

In the case where the user presses one of the keys of the keyboard 2, or where a key pressed by the user is released, the electronic apparatus 1 performs the lighting control process of lighting the LEDs 5 based on the control information 20. The procedure in which the electronic apparatus 1 performs the lighting control process will be described with reference to the flowchart shown in FIG. 5. Hereinafter, the description will be made while the term “step” is omitted so that, for example, “step S101” is referred to as “S101”.

First, the CPU 11 determines whether any one of the keys of the keyboard 2 is pressed or not (S101). In this case, based on a detection that a key is pressed, it is determined that the key is pressed.

If a key is pressed (Yes in S101), the CPU 11 obtains the lighting information 22 associated with the key information 21 in the case of the key press, from the control information 20 stored in the HD (S103). Then, the CPU 11 causes the LEDs 5 to be lighted, based on the lighting information 22 obtained in step S103 (S105).

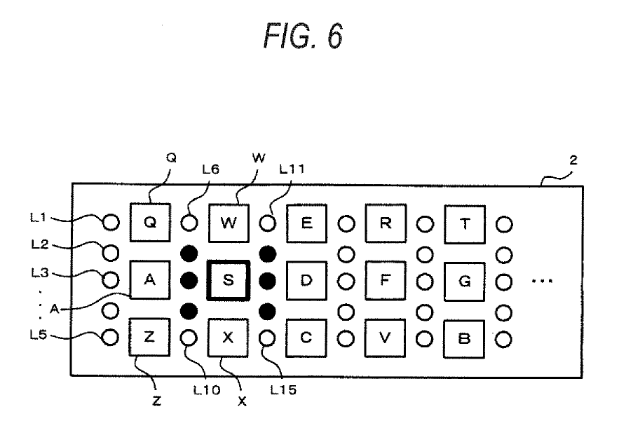

As shown in FIG. 6, when the user presses the key of S, for example, the CPU 11 obtains the lighting information 22 of “L7, L8, L9, L12, L13, L14” associated with the key information 21 in the case of the key press, from the control information 20, and, based on the information, causes the LEDs 5 of L7, L8, L9, L12, L13, and L14 to be lighted.

When the process of step S105 is ended, or when a key is not pressed (No in S101), the CPU 11 determines whether the key which is pressed in step S101 is released or not (S107). In this case, based on a detection that a key is released, it is determined that a key is released. If the key is not released (No in S107), the process returns to step S101, and the CPU 11 determines whether another key is pressed or not.

If the key is released (Yes in S107), the CPU 11 obtains the lighting information 24 associated with the key information 23 in the case of the key release, from the control information 20 stored in the HD (S109). Then, the CPU 11 causes the LEDs 5 to be lighted, based on the lighting information 24 obtained in step S109 (S111).

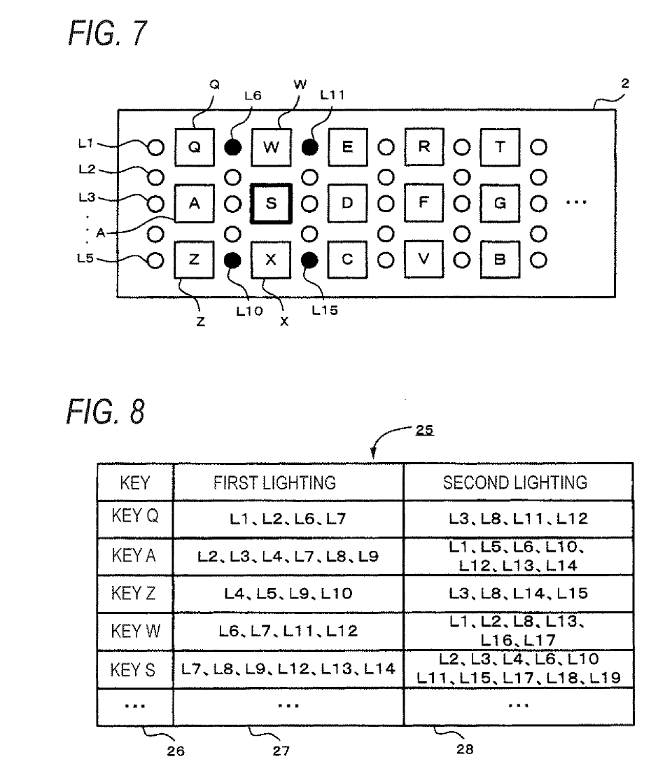

As shown in FIG. 7, when the user releases the key of S, for example, the CPU 11 obtains the lighting information 24 of “L6, L10, L11, L15” associated with the key information 23 of “Key S” in the case of the key release, from the control information 20, and, based on the information, causes the LEDs 5 of L6, L10, L11, and L15.

In this way, the electronic apparatus 1 repeats the process of steps S101 to S111, whereby, when a key is pressed, and when a key is released, the LEDs 5 are lighted based on the control information 20 stored in the HD.

In the electronic apparatus 1, after the LEDs 5 are lighted based on the press of a key, the lighted LEDs 5 may be unlighted based on the release of the pressed key. In this case, the LEDs 5 which are lighted in step S105 are unlighted in step S111 of FIG. 5.

The control information 20 stored in the HD may be information which is previously stored, or that which is input by the user through the keyboard 2. When a function of setting the methods of lighting and unlighting of the LEDs 5 is provided, the user can get a pleasure that lighting of the LEDs can be customized by oneself.

The HD may previously store information of keys which are to be pressed by user, so that the LEDs 5 are lighted before the user presses a key. The case where the user is to press keys of “Q, A, and Z” will be considered. The HD previously stores information indicating “Q, A, and Z”, and, based on the control information 20, the LEDs 5 associated with “Key Q” are first lighted. When it is detected that the user presses the key of Q, the LEDs 5 associated with “Key A” are next lighted. When it is then detected that the user presses the key of A, the LEDs 5 associated with “Key Z” are finally lighted. Accordingly, the user can know the key which is to be pressed, by the lighting of the LEDs 5.

The first embodiment includes the keyboard 2 in which the plurality of LEDs 5 are arranged around each of the keys, and, when one of the keys is pressed, the LEDs placed around the key are lighted, whereby the user can check whether the key input is correctly performed or not, and the keyboard 2 can be provided with visual value added. When the function of setting the methods of lighting and unlighting of the LEDs 5 is provided, the user can get a pleasure that lighting of the LEDs 5 can be customized by oneself.

### Second Embodiment

A second embodiment of the electronic apparatus of the invention will be described with reference to FIGS. 8 to 11. The components identical with those of the first embodiment are denoted by the same reference numerals, and duplicate description will be omitted. In the same manner as the electronic apparatus 1 of the first embodiment, the electronic apparatus 1A of the second embodiment is a notebook Personal Computer (PC) which is usually used, or the like. In the electronic apparatus, as shown in FIG. 1, the keyboard 2 having a plurality of keys which are pressed when the user inputs instructions, the display device 3 which displays a screen showing characters, images, and the like, the speaker 4 which outputs sounds, and the plurality of LEDs 5 which are disposed in the keyboard 2, and which are lighted based on press of keys of the keyboard 2 are disposed so as to be exposed to the outside.

Similarly with the electronic apparatus 1 of the first embodiment, as shown in FIG. 1, as shown in FIG. 2, the electronic apparatus 1A includes at least the Central Processing Unit (CPU) 11, the Random Access Memory (RAM) 12, the Hard Disk (HD) drive 13, the Read Only Memory (ROM) drive 14, the GPU 15, and the audio codec 16. These components are interconnected by the chip set 17.

The plural keys of the keyboard 2 and the plural LEDs 5 are arranged in the same manner as those in the first embodiment. Namely, in the keyboard 2, the plural keys are arranged in a lattice-like manner as shown in FIG. 3. Columns of the LEDs 5 which are vertically arranged are disposed between respective columns of the keys which are similarly vertically arranged, so that the columns of the keys and those of the LEDs 5 are alternately arranged. As shown in FIG. 3, for example, five LEDs 5 (the identification numbers are L1 to L5) are arranged between the column of the keys of Q, A, and Z and that of the keys of W, S, and X. Moreover, five LEDs 5 (the identification numbers are L6 to L10) are arranged between the column of the keys of W, S, and X and that of the keys of E, D, and C.

The HD stores control information 25 indicating the method of lighting the LEDs 5 in the case where a key of the keyboard 2 is pressed. In the control information 25, as shown in FIG. 8, sets of key information 26 indicating the keys of the keyboard 2 are associated with those of first lighting information 27 indicating the LEDs 5 which are first lighted when a corresponding key is pressed, respectively, and sets of second lighting information 28 indicating the LEDs 5 which are second lighted when the corresponding key is pressed, respectively.

According to FIG. 8, for example, the key information 26 of “Key Q” is associated with the first lighting information 27 of “L1, L2, L6, L7”, and the second lighting information 28 of “L3, L8, L11, L12”. Furthermore, the key information 26 of “Key A” is associated with the first lighting information 27 of “L2, L3, L4, L7, L8, L9”, and “L1, L5, L6, L10, L12, L13, L14”. This means that, when the key of Q is pressed, the LEDs 5 of L1, L2, L6, and L7 are first lighted, and then the LEDs 5 of L3, L8, L11, and L12 are second lighted. Moreover, this means that, when the key A is pressed, the LEDs 5 of L2, L3, L4, L7, L8, and L9 are first lighted, and then the LEDs 5 of L1, L5, L6, L10, L12, L13, and L14 are second lighted.

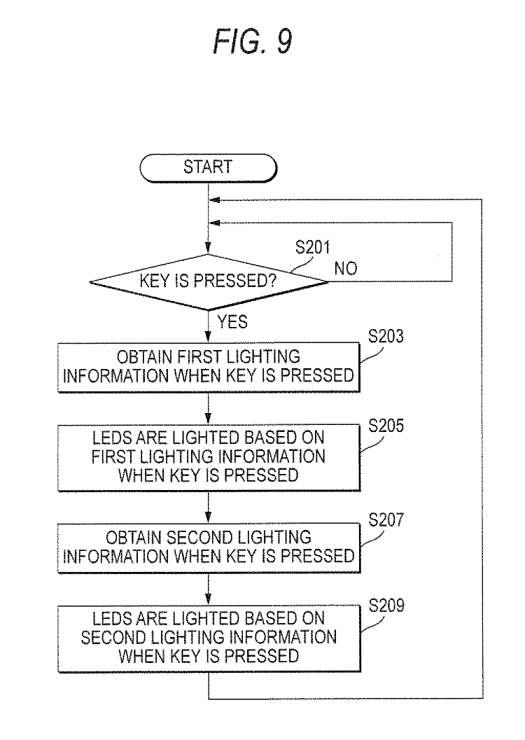

In the case where the user presses one of the keys of the keyboard 2, the electronic apparatus 1A performs a lighting control process of sequential (with a time difference) lighting the LEDs 5 based on the control information 25. The procedure in which the electronic apparatus 1A performs the lighting control process will be described with reference to the flowchart shown in FIG. 9.

First, the CPU 11 determines whether any one of the keys of the keyboard 2 is pressed or not (S201). In this case, based on a detection that a key is pressed, it is determined that the key is pressed. If a key is not pressed (No in S201), the CPU 11 waits until a key is pressed.

If a key is pressed (Yes in 5201), the CPU 11 obtains the first lighting information 27 associated with the key information 26, from the control information 25 stored in the HD (S203). Then, the CPU 11 causes the LEDs 5 to be lighted, based on the first lighting information 27 obtained in step S203 (S205).

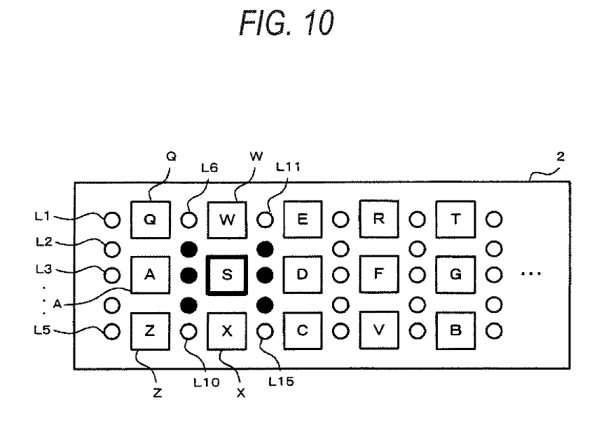

As shown in FIG. 10, when the user presses the key of S, for example, the CPU 11 obtains the first lighting information 27 of “L7, L8, L9, L12, L13, L14” associated with the key information 26 of “Key S”, from the control information 25, and, based on the information, causes the LEDs 5 of L7, L8, L9, L12, L13, and L14 to be lighted.

Next, the CPU 11 obtains the second lighting information 28 associated with the key information 26, from the control information 25 stored in the HD (S207). Then, the CPU 11 causes the LEDs 5 to be lighted, based on the lighting information 28 obtained in step S207 (S209).

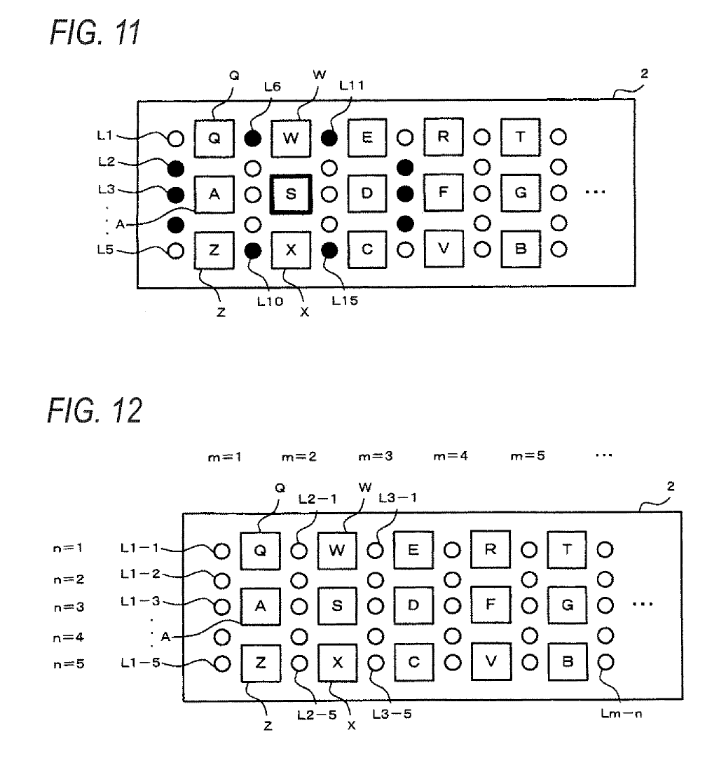

As shown in FIG. 11, when the user presses the key of S, for example, the CPU 11 obtains the second lighting information 28 of “L2, L3, L4, L6, L10, L11, L15, L17, L18, L19” associated with the key information 26 of “Key S”, from the control information 25, and, based on the information, causes the LEDs 5 of L2, L3, L4, L6, L10, L11, L15, L17, L18, and L19 to be lighted.

In this way, the electronic apparatus 1A repeats the process of steps S201 to S209, whereby, when a key is pressed, the LEDs 5 are sequentially lighted based on the control information 25 stored in the HD. Depending on the data stored as the control information 25, when a key is pressed, for example, the LEDs 5 may be lighted in such a manner that lighted LEDs are seen so as to sequentially expand in a ripple-like manner, or that lighted LEDs are seen so as to sequentially flow in a wave-like manner.

Although, in the second embodiment, the example in which the LEDs 5 are lighted in two steps by using the first lighting information 27 and the second lighting information 28 has been described, the invention is not restricted to this. The control information 25 may have third lighting information, fourth lighting information, and the like, so that the LEDs 5 are lighted in arbitrary plural steps.

The control information 25 stored in the HD may be information which is previously stored, or that which is input by the user through the keyboard 2. When a function of setting the methods of lighting and unlighting of the LEDs 5 is provided, the user can get a pleasure that lighting of the LEDs can be customized by oneself.

The second embodiment includes the keyboard 2 in which the plurality of LEDs 5 are arranged around each of the keys, and, when one of the keys is pressed, the LEDs placed around the key are lighted, whereby the user can check whether the key input is correctly performed or not, and the keyboard 2 can be provided with visual value added. When the function of setting the methods of lighting and unlighting of the LEDs 5 is provided, the user can get a pleasure that lighting of the LEDs 5 can be customized by oneself.

### Third Embodiment

A third embodiment of the electronic apparatus of the invention will be described with reference to FIGS. 12 to 16. The components identical with those of the first embodiment are denoted by the same reference numerals, and duplicate description will be omitted. In the same manner as the electronic apparatus 1 of the first embodiment, the electronic apparatus 1B of the third embodiment is a notebook Personal Computer (PC) which is usually used, or the like. In the electronic apparatus, as shown in FIG. 1, the keyboard 2 having a plurality of keys which are pressed when the user inputs instructions, the display device 3 which displays a screen showing characters, images, and the like, the speaker 4 which outputs sounds, and the plurality of LEDs 5 which are disposed in the keyboard 2, and which are lighted based on press of keys of the keyboard 2 are disposed so as to be exposed to the outside.

Similarly with the electronic apparatus 1 of the first embodiment, as shown in FIG. 1, as shown in FIG. 2, the electronic apparatus 1B includes at least the Central Processing Unit (CPU) 11, the Random Access Memory (RAM) 12, the Hard Disk (HD) drive 13, the Read Only Memory (ROM) drive 14, the GPU 15, and the audio codec 16. These components are interconnected by the chip set 17.

The plurality of keys and the plurality of LEDs 5 are arranged on the face of the keyboard 2. FIG. 12 shows an example of the arrangement of the plural keys and LEDs 5 on the keyboard 2. In the keyboard 2, the plural keys through which the user can input characters and commands are arranged in a lattice-like manner. Columns of the LEDs 5 which are vertically arranged are disposed between respective columns of the keys which are similarly vertically arranged, so that the columns of the keys and those of the LEDs 5 are alternately arranged. As shown in FIG. 12, for example, five LEDs 5 (the identification numbers are L1-1 to L1-5) are arranged between the column of the keys of Q, A, and Z and that of the keys of W, S, and X. Moreover, five LEDs 5 (the identification numbers are L2-1 to L2-5) are arranged between the column of the keys of W, S, and X and that of the keys of E, D, and C.

In order to identify the LEDs 5, the LEDs 5 are provided with identification numbers Lm-n in which “m” is a number indicating a vertical column, and sequentially incremented with starting from the left side in a plan view, and “n” is a number indicating a lateral column, and sequentially incremented with starting from the upper side in a plan view. The identification numbers are used in calculation expressions for lighting the LEDs 5.

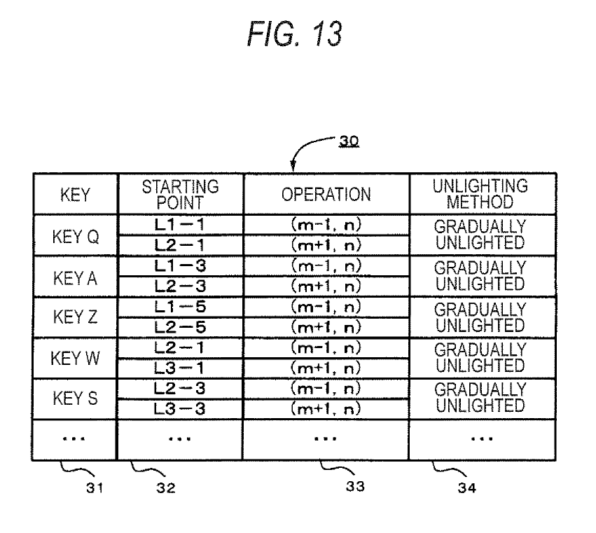

The HD stores control information 30 indicating the method of lighting the LEDs 5 in the case where a key of the keyboard 2 is pressed. In the control information 30, as shown in FIG. 13, sets of key information 31 indicating the keys of the keyboard 2 are associated with those of starting point information 32 indicating LEDs which are to be first lighted when a key is pressed, operation information 33 indicating the operation of the LEDs 5 after the LEDs 5 at the start point, and unlighting information 34 indicating the operation when the lighted LEDs 5 are unlighted, respectively. For example, the sets of unlighting information 34 include “gradually unlighted”, “instantly unlighted”, etc.

According to FIG. 13, for example, the key information 31 of “Key Q” is associated with the starting point information 32 of “L1-1” and “L2-1”, the operation information 33 of “(m−1, n)” and “(m+1, n)”, and the unlighting information 34 of “gradually unlighted”. In the operation information 33, “(m−1, n)” is a calculation expression for lighting LEDs 5 in which, with respect to the LEDs 5 that are first lighted, the vertical column is shifted by −1 and the lateral column is shifted by 0, and “(m+1, n)” is a calculation expression for lighting LEDs 5 in which the vertical column is shifted by +1 and the lateral column is shifted by 0. Namely, the expressions mean that, in the case where the key of Q is pressed, the LEDs 5 of L1-1 and L2-1 are first lighted; next, no LED is lighted with respect to L1-1 and L3-1 is lighted with respect to L2-1; and, then, no LED is lighted with respect to L1-1 and L4-1 is lighted with respect to L2-1. Then, the lighted LEDs are gradually unlighted.

According to FIG. 13, moreover, the key information 31 of “Key A” is associated with the starting point information 32 of “L1-3” and “L2-3”, the operation information 33 of “(m−1, n)” and “(m+1, n)”, and the unlighting information 34 of “gradually unlighted”. In the case where the key of A is pressed, similarly, the LEDs 5 of L1-3 and L2-3 are first lighted; next, no LED is lighted with respect to L1-3 and L3-3 is lighted with respect to L2-3; and, then, no LED is lighted with respect to L1-3 and L4-3 is lighted with respect to L2-3. The lighted LEDs are gradually unlighted.

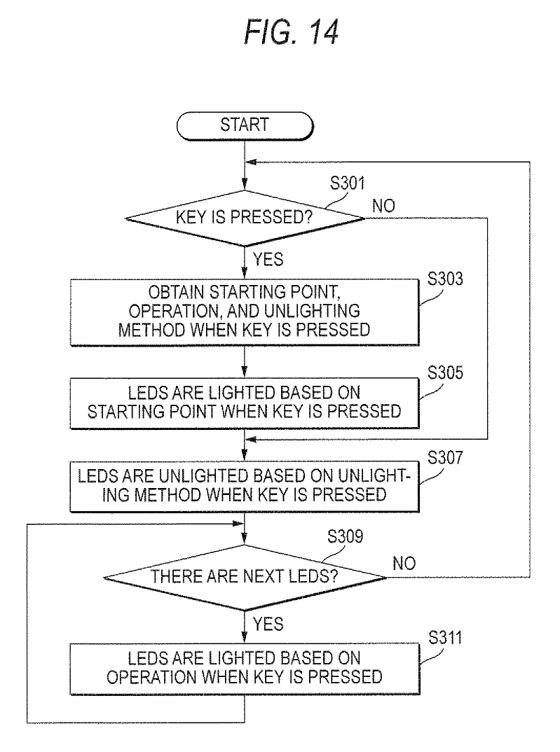

In the case where the user presses one of the keys of the keyboard 2, the electronic apparatus 1B performs a lighting control process of sequential lighting the LEDs 5 based on the control information 30. The procedure in which the electronic apparatus 1B performs the lighting control process will be described with reference to the flowchart shown in FIG. 14.

First, the CPU 11 determines whether any one of the keys of the keyboard 2 is pressed or not (S301). In this case, based on a detection that a key is pressed, it is determined that the key is pressed. If a key is not pressed (No in S301), the CPU 11 waits until a key is pressed.

If a key is pressed (Yes in S301), the CPU 11 obtains the starting point information 32, operation information 33, and unlighting information 34 which are associated with the key information 31, from the control information 30 stored in the HD (5303). Then, the CPU 11 causes the LEDs 5 to be lighted, based on the starting point information 32 obtain in step S303 (S305).

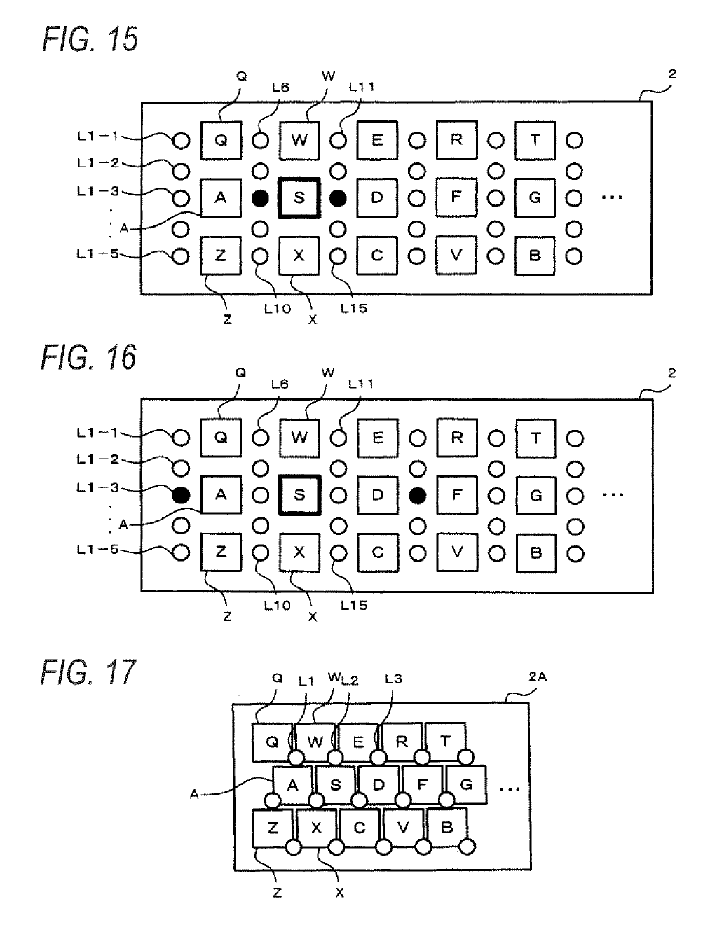

As shown in FIG. 15, when the user presses the key of S, for example, the CPU 11 obtains the starting point information 32 of “L2-3” and “L3-3” associated with the key information 31 of “Key S”, from the control information 30, and, based on the information, causes the LEDs 5 of L2-3 and L3-3 to be lighted.

Based on the unlighting information 34 obtained in step 5303, the CPU 11 causes the LEDs 5 which are lighted in step S305 to be unlighted (S307). For example, the CPU obtains “gradually unlighted” which is the unlighting information 34 associated with the key information 31 of “Key S”, from the control information 30, and, based on this information, causes the LEDs 5 of L2-3 and L3-3 to be gradually unlighted.

The CPU 11 determines whether there are LEDs 5 to be next lighted or not (S309). This is determined on the basis of the operation information 33 which is obtained in step S303. If there are LEDs 5 to be next lighted (Yes in S309), the CPU 11 causes the next LEDs based on the operation information 33 (S311).

As shown in FIG. 16, for example, the CPU obtains “(m−1, n)” and “(m+1, n)” which are the operation information 33 associated with the key information 31 of “Key S”, from the control information 30, and, based on this information, causes the LEDs 5 to be lighted. In this case, (m−1, n) with respect to L2-3 is L1-3, and (m+1, n) with respect to L3-3 is L4-3. Then, the CPU 11 causes the LEDs 5 of L1-3 and L4-3 to be lighted, based on the operation information 33 which is obtained in step S303 (S311).

If there are not LEDs 5 to be next lighted (No in S309), the process returns to step S301, and the CPU 11 determines whether a key is pressed or not. In this way, the electronic apparatus 1B repeats the process of steps S301 to S311, whereby, when a key is pressed, the LEDs 5 are lighted based on the control information 30. Depending on the calculation expressions stored in the control information 30, when a key is pressed, for example, the LEDs 5 may be lighted in such a manner that lighted LEDs are seen so as to sequentially expand in a ripple-like manner, or that lighted LEDs are seen so as to sequentially flow in a wave-like manner.

The method of controlling the LEDs 5 to be lighted is not restricted to that described in the third embodiment. Alternatively, the LEDs 5 may be sequentially lighted based on arbitrary calculation expressions which are previously stored in the HD, or calculation expressions which are input by the user through the keyboard 2 are stored in the HD as the control information 30, whereby the LEDs 5 may be lighted on the basis of the calculation expressions which are input by the user.

The third embodiment includes the keyboard 2 in which the plurality of LEDs 5 are arranged around each of the keys, and, when one of the keys is pressed, the LEDs placed around the key is lighted, whereby the user can check whether the key input is correctly performed or not, and the keyboard 2 can be provided with visual value added. When a function of setting the methods of lighting and unlighting of the LEDs 5 is provided, the user can get a pleasure that lighting of the LEDs 5 can be customized by oneself.

The arrangements of the keys and the LEDs 5 in the keyboard 2 are not restricted to the lattice-like arrangement shown in FIGS. 3 and 12, and may be a staggered arrangement as in a keyboard 2A shown in FIG. 17, or another arbitrary arrangement.

Although the electronic apparatuses 1, 1A, 1B of the invention have been described in the case where the function of implementing the invention is previously stored in the apparatus, the invention is not restricted to this. A similar function may be downloaded from a network to the apparatus, or a recording medium on which a similar function is stored may be installed on the apparatus. As the recording medium, a medium of any form such as a CD-ROM may be used as far as it can store programs and can be read by the apparatus.

1-8. (canceled)

9. An electronic apparatus including a keyboard in which a plurality of LEDs are arranged around each of keys, comprising:
a storage unit that stores a plural sets of information in which the LEDs are associated with each of the keys;
a detecting unit that detects a key input on the keyboard; and
an LED controlling unit that, when a key input is detected by the detecting unit, lights LEDs, in a sequential manner, which are associated with the input key in the storage unit, according to the plural sets of information stored in the storage unit.

10. An electronic apparatus including a keyboard in which a plurality of LEDs are arranged around each of keys, comprising:
a storage unit that stores first information and second information in which the LEDs are associated with each of the keys;
a detecting unit that detects a press of a key of the keyboard, and a release of a key; and
an LED controlling unit that, when a press of a key is detected by the detecting unit, lights LEDs which are associated with the pressed key according to the first information stored in the storage unit, and, when a release of the key is detected by the detecting unit, lights LEDs which are associated with the released key according to the second information stored in the storage unit.

11. An electronic apparatus including a keyboard in which a plurality of LEDs are arranged around each of keys, comprising:
a storage unit that stores first information for lighting LEDs, in a sequential manner, which are associated with each of the keys in the storage unit and second information for turning off the lighted LEDs;
a detecting unit that detects a key input on the keyboard; and
an LED controlling unit that, when a key input is detected by the detecting unit, controls lighting and turning off of LEDs according to the plural sets of information which is associated with the input key in the storage unit.

12. The electronic apparatus according to claim 9, further includes an input accepting unit that accepts an input of information for associating the LEDs with each of the keys,
wherein the storage unit stores information in which the LEDs are associated with each of the keys based on the information which is input through the input accepting unit.

13. The electronic apparatus according to claim 10, further includes an input accepting unit that accepts an input of information for associating the LEDs with each of the keys,
wherein the storage unit stores information in which the LEDs are associated with each of the keys based on the information which is input through the input accepting unit.

14. The electronic apparatus according to claim 11, further includes an input accepting unit that accepts an input of information for associating the LEDs with each of the keys,
wherein the storage unit stores information in which the LEDs are associated with each of the keys based on the information which is input through the input accepting unit
